(19) United States
(12) Patent Application Publication
(10) Pub. No.: US 2004/0020446 A1
(43) Pub. Date: Feb. 5, 2004

(54) Manure collection device for quadrupeds

(76) Inventor: Brian William. Paterson, Brighton (AU)

Correspondence Address: LARSON & TAYLOR, PLC, 1199 NORTH FAIRFAX STREET, SUITE 900, ALEXANDRIA, VA, 22314, US

(21) Appl. No.: 10/399,461

(22) PCT Filed: Oct. 19, 2001
(86) PCT No.: PCT/AU01/01333

(30) Foreign Application Priority Data
Oct. 19, 2000 (AU) PR 0839
Jan. 12, 2001 (AU) PR 2510

(51) Int. Cl. A01K 23/00

(52) U.S. Cl. 119/868

(57) ABSTRACT

A manure collection device (10) for a quadruped, having: a manure collection receptacle (12); a support Harness (28) for said manure collection receptable (12); wherein said support harness (28) is configured to support said manure collection receptacle adjacent said anus of said rump of said quadruped or substantially reaward of said rump of said quadruped, so that said manure is collected substantially above said level of said legs of said quadruped.

### FIELD OF THE INVENTION

The present invention relates to a nappy (or diaper) for quadrupeds, of particular but by no means exclusive application in providing a nappy for horses that may be used while the horse is being ridden or is drawing a coach.

### BACKGROUND OF THE INVENTION

Current manure collection devices for, in particular, horses are unsuitable for riding and harness horses as they hang too low and strike the horse on the back of the thighs when the horse is exercising.

Other existing devices allow the manure to travel down and between the horse's legs, to be stored in a receptacle under the horse's chest. However, this arrangement allows excessive swinging of the manure receptacle and thereby causes rubbing between the horse's legs.

Further, when female horses urinate existing manure collection devices do not allow the urine stream to be collected and stored separately from the manure. The urine typically sprays against the manure collection bag, and is consequently largely lost. Indeed, some of the urine sprays against the mare's body. Other existing manure collection devices allow the mare's urine to enter the same compartment as the manure, causing the manure to absorb the urine and increase in weight; this increases the tendency of the device to swing during exercise, further increasing rubbing of the mare's body. In addition, such devices are typically slung lower behind the mare to allow the urine to be collected, but this leads to still greater swinging and is unsuitable for riding or harness work.

### SUMMARY OF THE INVENTION

The present invention provides, therefore, a manure collection device for a quadruped, having:

a manure collection receptacle; and

a support harness for said manure collection receptacle;

wherein said support harness is configured to support said manure collection receptacle adjacent the anus of said quadruped or substantially rearward of the rump of said quadruped, so that said manure is collected substantially above the level of the legs of said quadruped, and said manure collection device includes a standoff for supporting said manure collection receptacle so that, in use with a female quadruped, said manure collection receptacle is removed from said quadruped in the region of the urethra, whereby, in use with a female quadruped, urine can flow freely downwardly from said urethra between said quadruped and said manure collection receptacle.

Preferably said manure collection receptacle has a closeable manure discharge means for allowing manure to be discharged from said manure collection receptacle and located to allow manure to be removed from said manure collection receptacle while said device is attached to said quadruped.

Thus, manure can be removed from the manure collection receptacle without removing the device from the quadruped.

Preferably said discharge means is located so that, in use, said discharge means is operable to discharge manure either rearwardly, downwardly, or both rearwardly and downwardly.

Preferably said discharge means comprises a cap threadedly engageable with a threaded portion of said manure collection receptacle surrounding an aperture in said receptacle.

Thus, the cap can be unscrewed to remove manure, and then screwed back onto the manure collection receptacle.

Alternatively, said discharge means comprises a flap located adjacent said manure collection receptacle, and provided with fastening means (such as at least one zipper or Velcro brand fastener) to allow said manure collection receptacle to be emptied or removed.

Preferably said manure collection receptacle includes a fluid permeable portion located to allow fluid to escape said manure collection receptacle when said device is in use, while retaining said manure. Preferably said fluid permeable portion comprises a mesh or a plurality of urine drainage holes.

Thus, the manure collection receptacle will not become heavy with urine and/or faecal fluid.

Preferably said device includes a fluid collection receptacle for collecting fluid that has escaped said manure collection receptacle through said fluid permeable portion.

Thus, urine (in the case of female quadrupeds) and faecal fluid can be collected.

In one embodiment, said manure collection receptacle has an opening for receiving said manure that, in use with a female quadruped, is above the urethra of said quadruped so that urine from said quadruped does not enter said manure collection receptacle.

Preferably said standoff comprises a cross-member (preferably having a plurality of fingers) with means for supporting said manure collection receptacle away from said quadruped, to allow said urine to pass between said manure collection receptacle and said cross-member.

The cross-member also acts as a cushion and further reduces manure collection receptacle swing against the mare's buttocks. The fingers (preferably of rubber) support the manure collection receptacle to sit higher up and under the anus of the horse for a more comfortable fit. The manure is disbursed over the length of the cross-member, so swing is limited as the fingers hold the bag outward.

Preferably said device is provided with a urine collection receptacle for collecting said urine.

In another embodiment, said manure collection receptacle is detachable from said device so that said manure collection receptacle can be detached for emptying or cleaning. Preferably said manure collection receptacle is detachable from said device while said device is attached to said quadruped.

Preferably said device is adapted to be attachable to a girth strap, so that in use any lateral movement of said device is reduced.

Preferably said urine collection receptacle is locatable beneath said quadruped. More preferably said urine collection receptacle is adapted to be attached to a girth strap.

The present invention also provides a method of collecting manure from a quadruped, involving providing said quadruped with a manure collection device as described above.

### BRIEF DESCRIPTION OF THE DRAWINGS

In order that the present invention may be more clearly ascertained, preferred embodiments will now be described, by way of example, with reference to the accompanying drawings, in which:

FIG. 1 is a side view of a coach manure collection device according to a preferred embodiment of the present invention;

FIG. 2 is a perspective view of the front of the device of FIG. 1;

FIG. 3 is a plan view of the device of FIG. 1;

FIG. 4 is a front view of the device of FIG. 1;

FIG. 5 is a rear view of a portion of the device of FIG. 1;

FIG. 6 is a side view of the manure bag of the device of FIG. 1 in use, with the nappy of the device of FIG. 1 omitted for clarity; and

FIG. 7 is a top view of the standoff and manure bag of the device of FIG. 1.

### DETAILED DESCRIPTION OF THE INVENTION

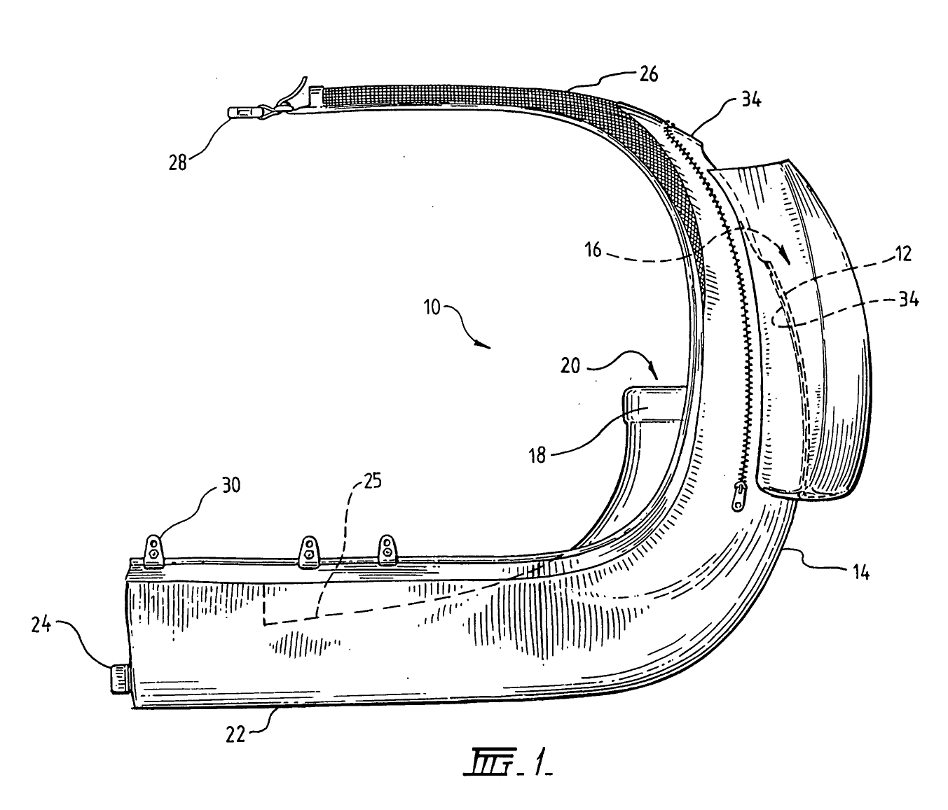

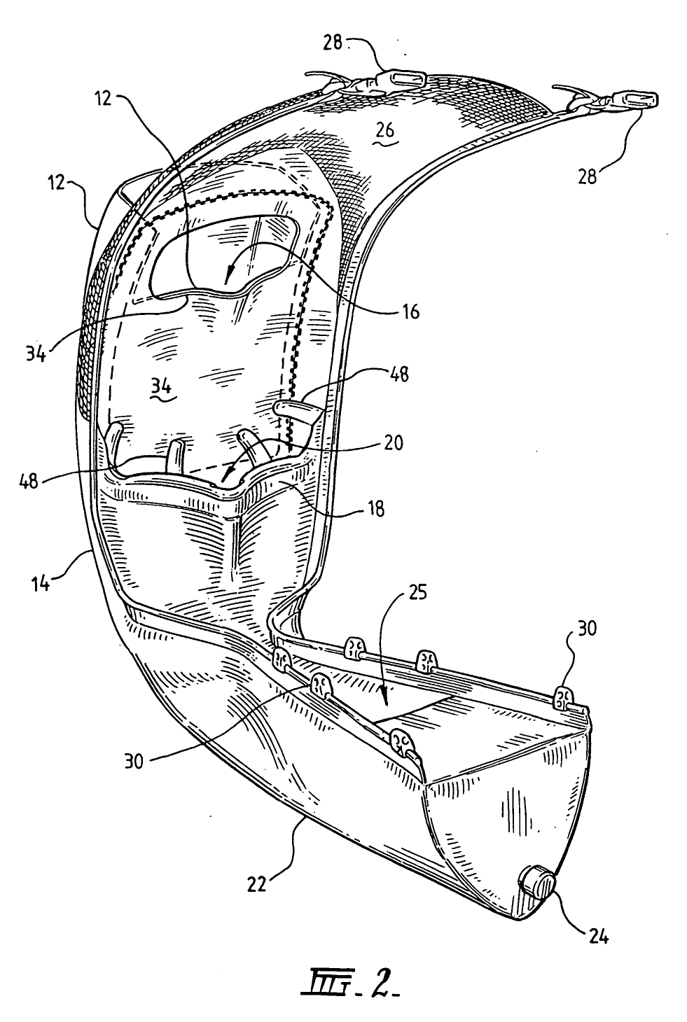

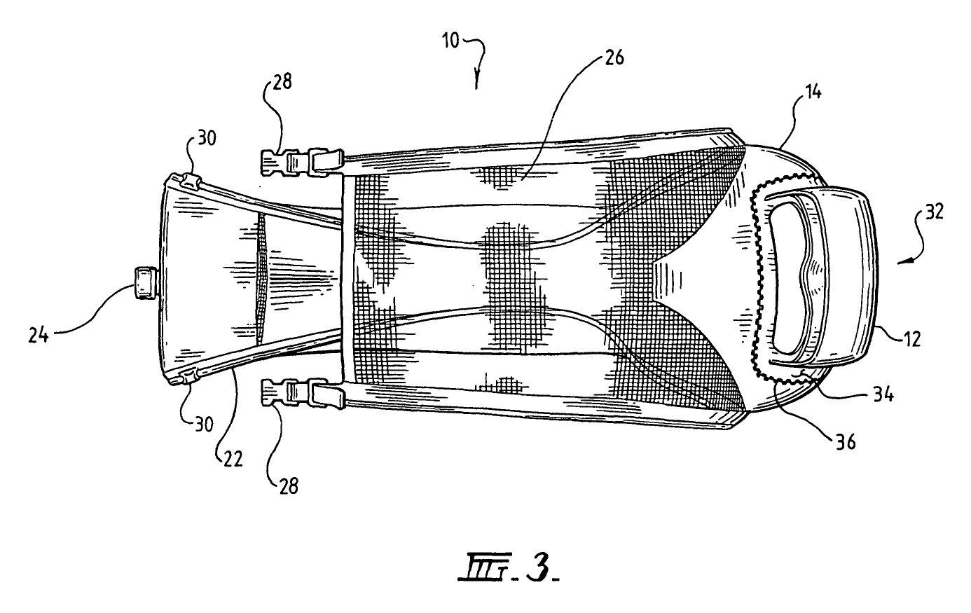

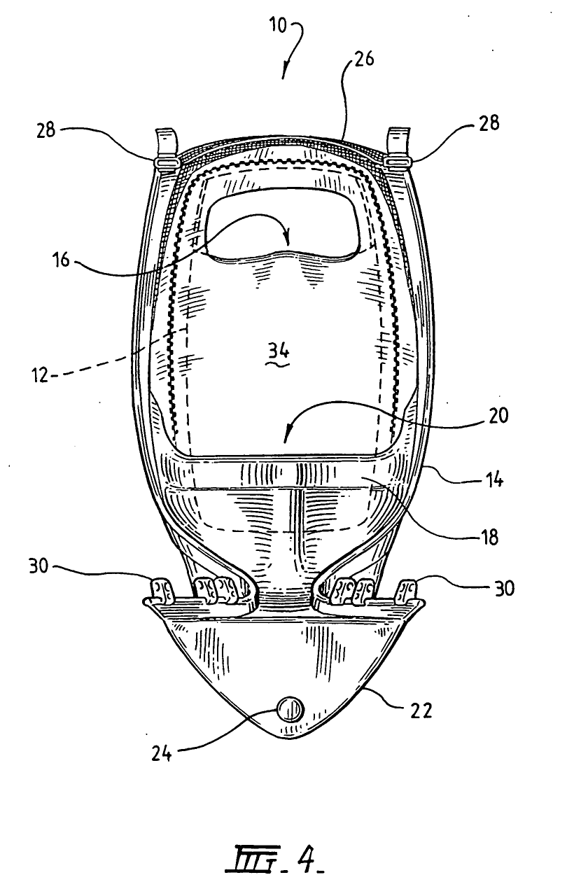

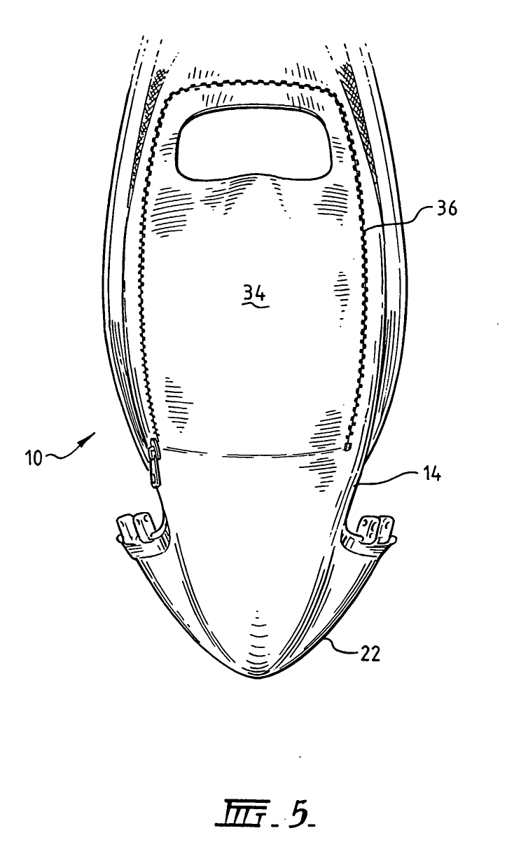

Referring to FIGS. 1 to 5, a coach manure collection device for a horse according to a preferred embodiment of the present invention is shown generally at 10. The device 10 includes a removable manure collection bag 12 located within nappy or diaper 14. The bag 12 has an upwardly directed opening 16 for receiving, in use, manure from the horse.

The rear of the device 10 is held out from the buttocks of the horse by means of a rubber standoff 18; the standoff 18 includes generally horizontal fingers (not shown) that hold the manure bag 12 out from the standoff 18 and, therefore, from the horse. Consequently, a passage 20 is provided between the standoff 18 and the nappy 14, below the bag opening 16, and to allow urine (in the case of a mare) and faecal fluid to pass between the manure bag 12 and the rump of the horse. Thus, most of the urine passes between the standoff 18 and the manure bag 12 and is collected into a conduit (not shown) within the nappy 14. This conduit passes between the horse's hind legs within the device 10, into a urine bladder (not shown) within the lower portion 22 of the device 10. The bladder is provided with a threaded emptying cap 24, so that urine can be emptied from the bladder.

Collecting urine from male horses is a far simpler matter; the stallion's penis is dropped into a bowl area 25 within the lower portion 22 to urinate. The urine flows through an inlet valve (not shown) into the urine bladder.

The nappy 14 includes a mesh upper portion 26 terminating in buckles 28 for strapping the device 10 to the horse. The lower portion 22 of the device 10 includes attachment points 30 for facilitating this attachment, and for supporting the lower portion 28 and the weight of the urine bladder therein.

The manure bag 12, being located relatively high on the horse's rump, above the horse's hindquarters, prevents manure from moving down between the horse's legs, thereby reducing the tendency of the manure bag 12 to swing as the horse exercises or rub against the horse.

The device 10 also includes a quick release system 32 for removing manure from the device 10. The quick release system 32 comprises a flap 34 with a zipper 36 (or alternatively a Velcro brand fastener). The flap 34 can unzipped up one side, across its top and down the other side, but remains attached along its lower side to the nappy 14. The manure bag 12 is attached to the flap 34 by means of press studs (not shown) for quick removal and accuracy of positioning; additional studs or clips (not shown) are located either side of the opening 16 of the manure bag 12 to attach the manure bag 12 to the forward edge of the nappy 14. To remove manure from the manure bag 12, the flap 34 is unzipped, and opened backwards and downwards. Manure can then either be poured out, or the manure bag 12 can be unclipped and removed and emptied as desired.

Carriage horses generally do not work for more than six hours continuously, so the manure and urine weight should not exceed 10 kg. If the driver believes the device 10 is heavy with urine and manure, he or she can empty the manure from the back of the device 10 by means of the quick release system 32 into a suitable airtight container (which could be stowed under the carriage) or into a manure/urine bin along the carriage's route.

As discussed above, urine is released from the front of the nappy 14 by means of cap 24, and emptied into a watertight container. The device 10 thereby allows urine and manure to be kept separate, and reduces the amount of weight under the horse's chest/stomach region. The quick release system 32 for the manure bag 12.

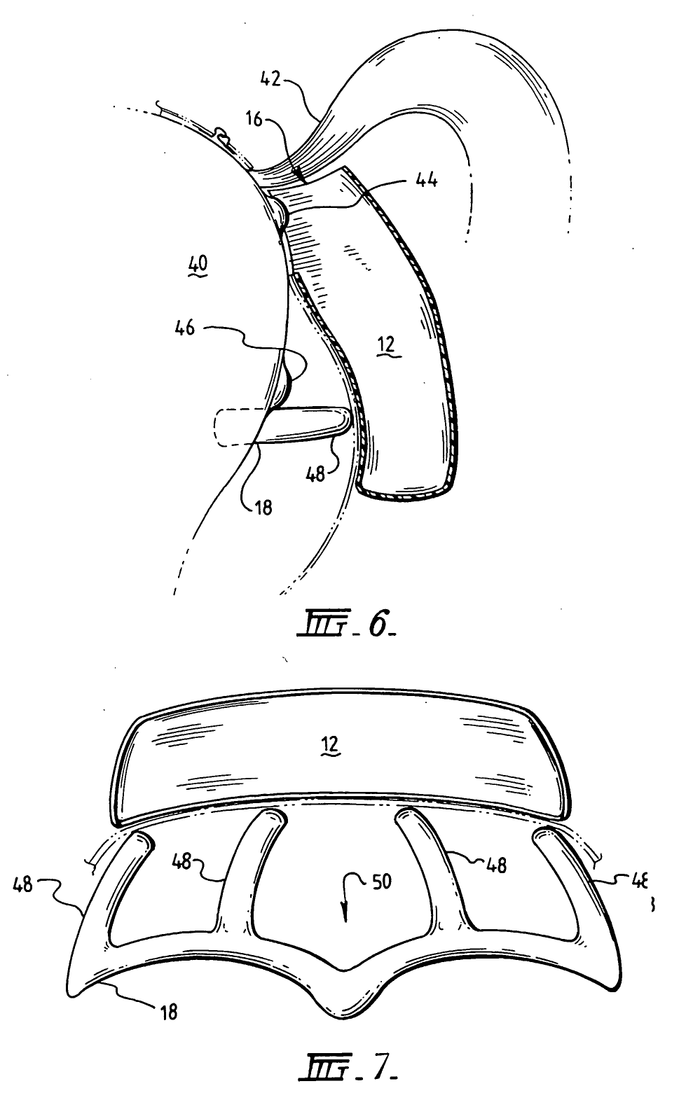

FIG. 6 is a view of the manure bag 12 in use with a horse 40, with the nappy 14 omitted for clarity. The horse's tail 42, anus 44 and (for a mare) urethra 46 are also indicated. As is apparent from the view, the manure bag 12 sits high on the horse's rump and is held away from the horse's buttocks by the fingers 48 of the standoff 18. Further, it is clear that urine from the urethra 46 will not enter the manure bag 12, but rather pass between the standoff 18 and the manure bag 12.

FIG. 7 is a top view of the rubber standoff 18 showing the fingers 48 and the relative location of the manure bag 12. The fingers 48 allow urine from mares to drain 50 between the manure bag 12 and the standoff 18. The rubber standoff 18 also acts as a cushion and greatly reduces any bag swing against the horse's buttocks. The rubber fingers 48 support the manure bag 12 so that it sits higher up and under the anus of the horse and more comfortably. Manure is disbursed over the width of the standoff 18 so that swing is limited, as the rubber fingers 48 hold the bag 12 outward.

Modifications within the spirit and scope of the invention may be readily effected by those skilled in the art. It is to be understood, therefore, that this invention is not limited to the particular embodiments described by way of example hereinabove.

1. A manure collection device for a quadruped, having:
a manure collection receptacle; and
a support harness for said manure collection receptacle;
wherein said support harness is configured to support said manure collection receptacle adjacent the anus of said quadruped or substantially rearward of the rump of said quadruped, so that said manure is collected substantially above the level of the legs of said quadruped, and said manure collection device includes a standoff for supporting said manure collection receptacle so that, in use with a female quadruped, said manure collection receptacle is removed from said quadruped in the region of the urethra, whereby, in use with a female quadruped, urine can flow freely downwardly from said urethra between said quadruped and said manure collection receptacle.

2. A manure collection device as claimed in claim 1, wherein said manure collection receptacle has a closeable manure discharge means for allowing manure to be discharged from said manure collection receptacle and located to allow manure to be removed from said manure collection receptacle while said device is attached to said quadruped.

3. A manure collection device as claimed in claim 2, wherein said discharge means is located so that, in use, said discharge means is operable to discharge manure either rearwardly, downwardly, or both rearwardly and downwardly.

4. A manure collection device as claimed in either claim 2 or 3, wherein said discharge means comprises a cap threadedly engageable with a threaded portion of said manure collection receptacle surrounding an aperture in said receptacle.

5. A manure collection device as claimed in either claim 2 or 3, wherein said discharge means comprises a flap located adjacent said manure collection receptacle, and provided with fastening to allow said manure collection receptacle to be emptied or removed.

6. A manure collection device as claimed in claim 5, wherein said fastening means comprises means at least one zipper.

7. A manure collection device as claimed in claim 5, wherein said fastening means comprises means at least one Velcro brand fastener.

8. A manure collection device as claimed in any one of the preceding claims, wherein said manure collection receptacle includes a fluid permeable portion located to allow fluid to escape said manure collection receptacle when said device is in use, while retaining said manure.

9. A manure collection device as claimed in claim 8, wherein said fluid permeable portion comprises a mesh or a plurality of urine drainage holes.

10. A manure collection device as claimed in any one of the preceding claims, wherein said device includes a fluid collection receptacle for collecting fluid that has escaped said manure collection receptacle through said fluid permeable portion.

11. A manure collection device as claimed in any one of the preceding claims, including an opening for receiving said manure that, in use with a female quadruped, is above the urethra of said quadruped so that urine from said quadruped does not enter said manure collection receptacle.

12. A manure collection device as claimed in any one of the preceding claims, wherein said standoff comprises a cross-member with means for supporting said manure collection receptacle away from said quadruped, to allow said urine to pass between said manure collection receptacle and said cross-member.

13. A manure collection device as claimed in claim 12, wherein said means for supporting said manure collection receptacle is in the form of a plurality of fingers.

14. A manure collection device as claimed in any one of the preceding claims, including a urine collection receptacle for collecting said urine.

15. A manure collection device as claimed in claim 14, wherein said urine collection receptacle is locatable beneath said quadruped.

16. A manure collection device as claimed in any one of the preceding claims, wherein said manure collection receptacle is detachable from said device so that said manure collection receptacle can be detached for emptying or cleaning.

17. A manure collection device as claimed in claim 15, wherein said manure collection receptacle is detachable from said device while said device is attached to said quadruped.

18. A manure collection device as claimed in any one of the preceding claims, wherein said device is adapted to be attachable to a girth strap, so that in use any lateral movement of said device is reduced.

19. A method of collecting manure from a quadruped, involving providing said Quadruped with a manure collection device as claimed in any one of the preceding claims.
